(19) United States
(12) Patent Application Publication
(10) Pub. No.: US 2010/0150232 A1
(43) Pub. Date: Jun. 17, 2010

(54) METHOD FOR CONCEALING A PACKET LOSS

(75) Inventors: Dieu Thanh Nguyen, Hannover (DE); Bernd Edler, Hannover (DE); Jorn Ostermann, Osnabruck (DE); Nikolce Stefanoski, Hannover (DE)

Correspondence Address: SEED INTELLECTUAL PROPERTY LAW GROUP PLLC, 701 FIFTH AVE, SUITE 5400, SEATTLE, WA, 98104, US

(73) Assignee: GOTTFRIED WILHELM LEIBNIZ UNIVERSITAT HANNOVER, Hannover (DE)

(21) Appl. No.: 12/446,744

(22) PCT Filed: Oct. 31, 2007
(86) PCT No.: PCT/EP2007/061791

§ 371 Date: Feb. 26, 2010

Related U.S. Application Data
(60) Provisional application No. 60/767,591, filed on Oct. 31, 2006.

(51) Int. Cl. H04N 7/12

(52) U.S. Cl. 375/240.12; 375/E07.243

(57) ABSTRACT

A method of concealing a packet loss during video decoding is provided. An input stream having a plurality of network abstraction layer units NAL is received. A loss of a network abstraction layer unit in a group of pictures in the input stream is detected. A valid network abstraction layer unit order from the available network abstraction layer units is outputted. The network abstraction layer unit order is received by a video coding layer (VCL) and data is outputted.

The invention relates to a method for concealing an error and a video decoding unit.

Exchanging video over the Internet with devices differing in screen size and computational power as well as with varying available bandwidth creates a logistic nightmare for each service provider when using conventional video codecs like MPEG-2 or H.264. Scalable video coding is not only a convenient solution to adapt the data rate to varying bandwidth in the Internet but also provides different end devices with appropriate video resolution and data rate. In January 2005, the ISO/IEC Moving Pictures Experts Group (MPEG) and the Video Coding Experts Group (VCEG) of the ITU-T started jointly the MPEG's Scalable Video Coding (SVC) project as an Amendment of the H.264/AVC standard. The scalable extension of H.264/AVC was selected as the first Working Draft as described in J. Reichel, H. Schwarz and M. Wien, “Scalable Video Coding—Working Draft I,” Joint Video Team of ITU-T VCEG and ISO/IEC MPEG, Doc. JVT-NO20, January 2005 and R. Schaefer, H. Schwarz, D. Marpe, T. Schierl and T, Wiegand, “MCTF and Scalability Extension of H.264/AVC and its Application to Video Transmission, Storage, and Surveillance,” Proc. VCIP 2005, Bejing, China, July 2005. Furthermore, the Audio/Video Transport (AVT) Working Group of the Internet Engineering Task Force (IETF) started in November 2005 to draft the RTF payload format for the scalable extension of H.264/AVC and the signaling for layered coding structures as described in S. Wenger, Y. K. Wang and M. Hannuksela, “RTF payload format for H.264/SVC scalable video coding,” 15th International Packet Video Workshop, Hangzhou, China, April 2006.

The scalable extension of H.264/AVC uses the structure of H.264/AVC that is divided into two parts, namely the Video Coding Layer (VCL) and the Network Abstraction Layer (NAL) as described in “H.264: Advanced video coding for generic audiovisual services,” International Standard ISO/IEC 14496-10:2005. In the VCL, the input video signal is coded. In the NAL, the output signal of the VCL is fragmented into so-called NAL units. Each NAL unit includes a header and a payload which can contain a frame, a slice or a partition of a slice. The advantage of this structure is that the slice type or the priority of this NAL unit can be obtained only by parsing of the 8-bit NAL unit header. The NAL is designed based on a principle called Application Level Framing (ALF) where the application defines the fragmentation into meaningful subsets of data named Application Data Unit (ADU) such that a receiver can cope with packet loss in a simple manner, it is very important for data transmission over network.

In multimedia communication, transmission errors such as packet loss or bit errors in storage medium causes erroneous bit streams. Therefore, it is necessary to add error control and concealment methods in the decoder. For the scalable extension of H.264/AVC a NAL unit is marked as lost and discarded if the bit error is not remedied by an error correction method. The error concealment methods defined in SVC project attempt to generate missing pictures in the Video Coding Layer by picture copy, up-sampling of motion and residual information from the base layer pictures or motion vector generation as described in J. Reichel, H. Schwarz, M. Wien, “Joint Scalable Video Model JSVM-6,” joint Video Team of ITU-T VCEG and ISO/IEC MPEG, Doc. JVT-5202, April 2006. With these methods the decoder can give the output video with maximal available frame rate and resolution. But there will be error drift if the error-concealed picture is used further as a reference picture for other pictures because the error-concealed picture differs from the same reconstructed picture without error. The amount of error drift depends on which spatial layer and temporal level the lost NAL unit belongs to.

Varying bandwidth and packet loss are inevitable problems for data transmission over the best-effort packet-switched networks like IP networks. Especially, for real-time transmission of multimedia data such as video, audio and graphics, a concealment method in the decoder at the receiver is always required in case of packet loss that causes an erroneous bit stream. Firstly, because multimedia data are coded to reduce the data rate before transmission nowadays and all of the coding standards which define the decoding process suppose that the coded data is received without error. Secondly, because the multimedia data are delay sensitive, so that the resend of lost packets makes no sense if the maximal required delay is exceeded or a late coming packet is treated as lost.

It is therefore an object of the invention to provide an improved method for concealing a packet loss.

This object is solved by a method for concealing a packet loss according to claim 1.

The invention relates to the idea to provide an error concealment method in the Network Abstraction Layer for the scalable extension of H.264/AVC. With the knowledge of the bit stream structure, a simple algorithm will be applied to create a valid bit stream from the erroneous bit stream. The output video will not achieve the maximal resolution or maximal frame rate of the non-erroneous bit stream, but there will be no error drift. This is the first error concealment method for the scalable extension of H.264/AVC that does not require parsing of the NAL unit payload or high computing power. Therefore, it is suitable for real-time video communication.

The scalable video coder employs different techniques to enable spatial, temporal and quality scalability as described in J. Reichel, H. Schwarz and M. Wien, “Scalable Video Coding—Working Draft I,” Joint Video Team of ITU-T VCEG and ISO/IEC MPEG, Doc. JVT-N020, January 2005 and R. Schaefer, H. Schwarz, D. Marpe, T. Schierl and T. Wiegand, “MCTF and Scalability Extension of H.264/AVC and its Application to Video Transmission, Storage, and Surveillance,” Proc. VCIP 2005, Bejing, China, July 2005. Spatial scalability is achieved by using a down-sampling filter that generates the lower resolution signal for each spatial layer. Either motion compensated temporal filtering (MCTF) or hierarchical B-pictures obtain a temporal decomposition in each spatial layer that enables temporal scalability. Both methods process input pictures at the encoder and the bit stream at the decoder in group of pictures (GOP) mode. A GOP includes at least one key picture and all other pictures between this key picture and the previous key picture, whereas a key picture is intra-coded or inter-coded by using motion compensated prediction from previous key pictures.

Further aspects of the invention are defined in the dependent claims.

Embodiments and advantages of the present invention will now be described with reference to the figures in more detail.

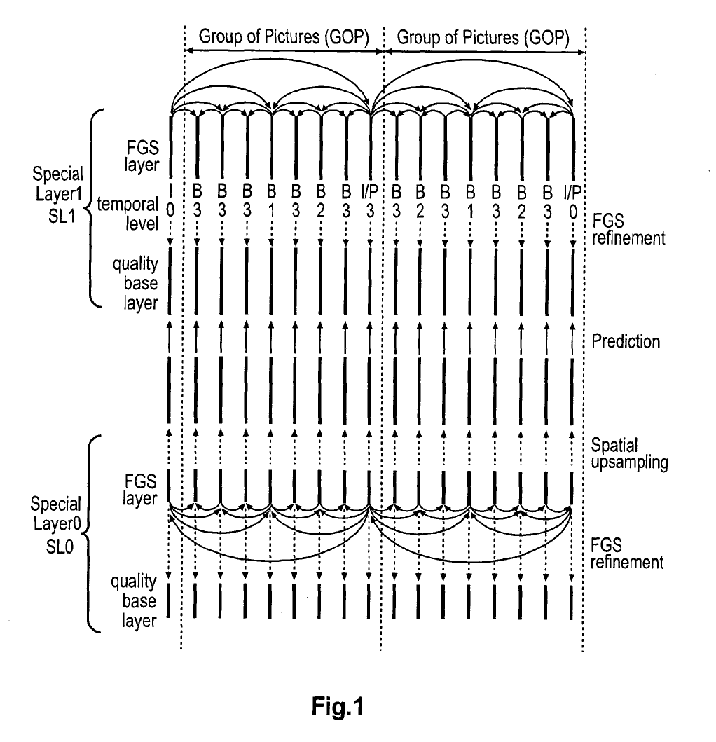

FIG. 1 shows a basic illustration of generating a scalable video bit stream according to a first embodiment,

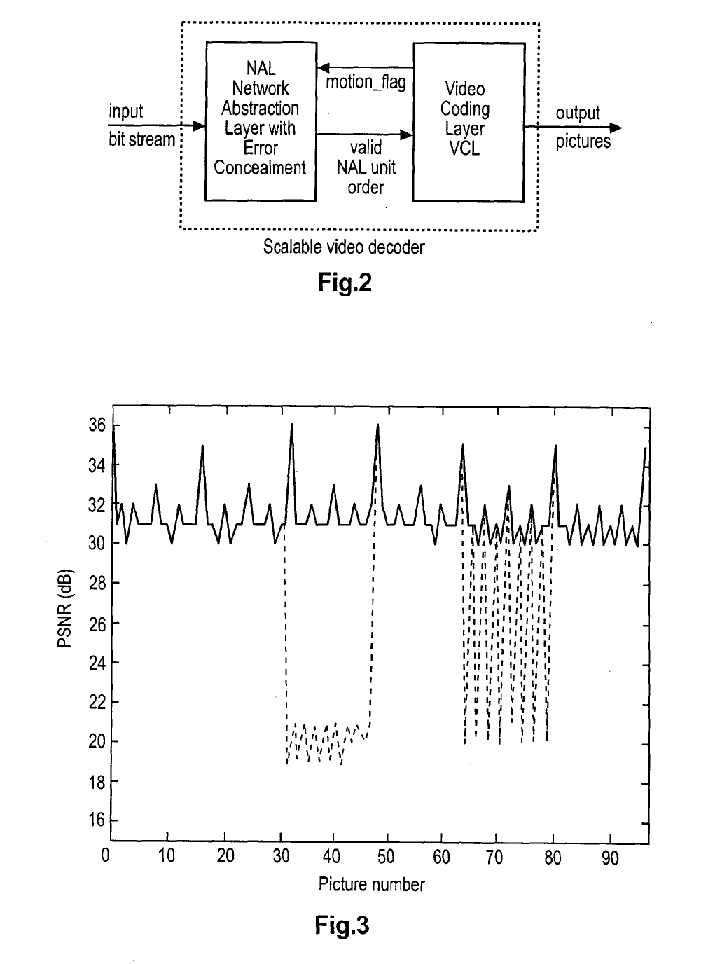

FIG. 2 shows a block diagram of a scalable video decoder according to the first embodiment,

FIG. 3 shows a graph of the PSNR of scalable video according to the first embodiment, and

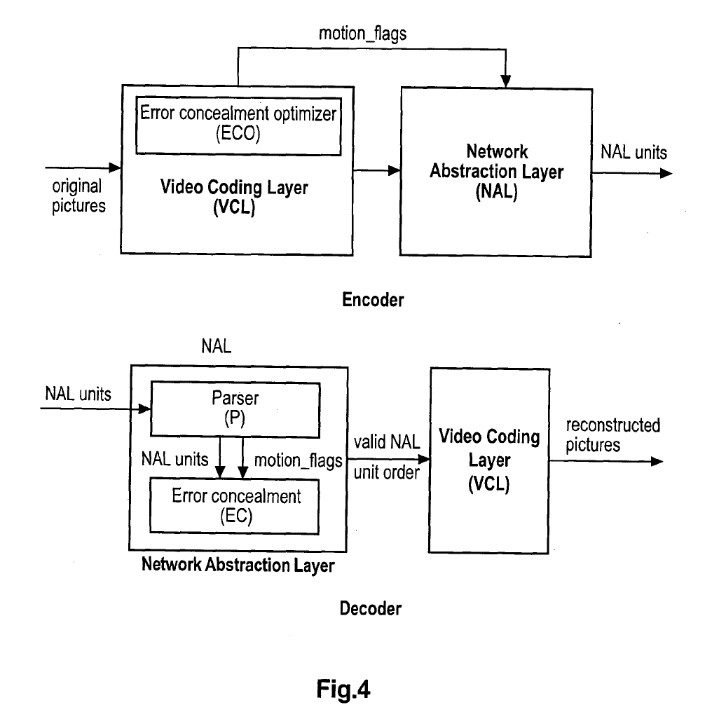

FIG. 4 shows a block diagram of an encoder and a decoder according to a second embodiment.

FIG. 1 shows a basic illustration of generating a scalable video bit stream according to a first embodiment. Here, the generation of a scalable video bit stream with 2 spatial layers SL0, SL1, 4 temporal levels, a quality base layer and a quality enhancement layer is depicted. The input pictures in layer 0 are created by down-sampling of the input pictures in layer 1 by a factor of two. In each spatial layer a group of pictures (GOP) is coded with hierarchical B-Picture techniques to obtain 4 temporal levels (i=0, 1, 2, 3). The key picture is coded as I- or P-picture and has temporal level 0. The direction of arrow point from the reference picture to the predicted picture. To remove redundancy within layers, motion and texture information of the temporal level in the lower spatial layer are scaled and up-sampled for prediction of motion and texture information in the current layer.

For each temporal level, the residual signal resulting from texture prediction is transformed. For quality scalability, the transform coefficients are coded by using a progressive spatial refinement mode to create a quality base layer and several quality enhancement layers. This approach is called fine grain scalability (FGS). The advantage of this approach is that the data of a quality enhancement layer (FGS layer) can be truncated at any arbitrary point to limit data rate and quality without impact on the decoding process,

In the FIG. 1, each solid slice corresponds to at least one NAL unit. It should be noted that with the error concealment methods proposed in SVC project the error will affect only one picture if the lost NAL unit belongs to the highest temporal level. The error drift is limited to the current GOP if the lost NAL unit is not in the quality base layer of the key picture. Otherwise, the error drift will expand in following GOPs until a key picture is coded as IDR-picture. An IDR-picture is an intra-coded picture and all of the following pictures are not allowed to use the pictures preceding this IDR picture as a reference.

Table 1 shows the NAL units order in a bit stream for a GOP with 2 spatial layers and 4 temporal levels, in the scalable extension of H.264/AVC the NAL header is extended to inform about the spatial layer, temporal level and FGS layer which this NAL unit presents. Because the quality enhancement layer (FGS index greater than 0) only degrades the quality of the corresponding picture and do not affect the decoder process if it is lost, it is not necessary to do error concealment for these NAL units. Therefore, only NAL units of the quality base layer (FGS index equal 0) are shown in Table 1 for simplification.

TABLE 1

| No. | Spat, layer | Temp, level | FGS |
|---|---|---|---|
| 1 | 0 | 0 | 0 |
| 2 | 1 | 0 | 0 |
| 3 | 0 | 1 | 0 |
| 4 | 1 | 1 | 0 |
| 5 | 0 | 2 | 0 |
| 6 | 1 | 2 | 0 |
| 7 | 0 | 2 | 0 |
| 8 | 1 | 2 | 0 |
| 9 | 0 | 3 | 0 |
| 10 | 1 | 3 | 0 |
| 11 | 0 | 3 | 0 |
| 12 | 1 | 3 | 0 |
| 13 | 0 | 3 | 0 |
| 14 | 1 | 3 | 0 |
| 15 | 0 | 3 | 0 |
| 16 | 1 | 3 | 0 |

The NAL units are serialized in decoding order, but not in picture display order. It begins with the lowest temporal level and the temporal level will be increased after the NAL units of all spatial layers for a temporal level are arranged. The number of NAL units for the quality base layer in each level can be calculated from the GOP size or from the number of temporal level which is found in the parameter sets at the beginning of a bit stream. That means the NAL unit order can be derived from the parameter sets sent at the beginning of a transmission.

FIG. 2 shows a block diagram of a scalable video decoder according to the first embodiment, i.e. a motion-based error concealment is achieved in the network upstraction layer. Here, the block diagram of the proposed scalable video decoder with error concealment in NAL is depicted. In the error concealment implementation according to the first embodiment it is assumed that the NAL units of a key picture in a GOP are not lost. For those NAL units a regular FEC (Forward Error Correction) method may be used as described in S. Lin and D. J. Costello, “Error Control Coding: Fundamentals and Application,” Englewood Cliffs, N.J.: Prentice-Hall, 1983. A lost NAL unit is defined as a NAL unit which belongs to a temporal level greater zero, if a NAL unit of a GOP is lost, a valid NAL unit order with a lower spatial resolution and/or lower frame rate is chosen. Accordingly, maximal available spatial layer and/or the maximal available temporal level of this GOP is reduced.

For example, if the 9-th NAL unit of a GOP in Table 1 is lost, the NAL unit order in Table 2 is computed to create a valid bit stream with the same resolution and only half of the original frame rate.

TABLE 2

| No. | Spat. layer | Temp. level | FGS |
|---|---|---|---|
| 1 | 0 | 0 | 0 |
| 2 | 1 | 0 | 0 |
| 3 | 0 | 1 | 0 |
| 4 | 1 | 1 | 0 |
| 5 | 0 | 2 | 0 |
| 6 | 1 | 2 | 0 |
| 7 | 0 | 2 | 0 |
| 8 | 1 | 2 | 0 |

In case that there are two possible valid NAL unit orders, the order with higher frame rate will be chosen if a lot of motion was observed in the last pictures. Otherwise, the order with the higher spatial resolution will be chosen. The motion flag given by VCL is set, if the average length of motion vectors in the last pictures is above a threshold. For example, if the 6-th or 8-th NAL unit of the GOP in, Table 1 is lost, two spatial layer and temporal level combinations in Table 3 and Table 4 can be achieved. The first has spatial layer 1 and temporal level 1. The second has spatial layer 0 and temporal level 3. If the original bit stream reaches the spatial resolution CiF and a frame rate of 30 Hz, than the first valid NAL unit order gives output pictures in (GIF, 7.5 Hz) and the second in (QCIF, 30 Hz). For the video segment with high motion the resolution (QCIF, 30 Hz) makes sense because the human eyes are motion sensible. Furthermore, all of rendering techniques are able to up-sample the picture to a certain spatial resolution using interpolation.

TABLE 3

| No. | Spat, layer | Temp, level | FGS |
|---|---|---|---|
| 1 | 0 | 0 | 0 |
| 2 | 1 | 0 | 0 |
| 3 | 0 | 1 | 0 |
| 4 | 1 | 1 | 0 |

TABLE 4

| No. | Spat, layer | Temp, level | FGS |
|---|---|---|---|
| 1 | 0 | 0 | 0 |
| 3 | 0 | 1 | 0 |
| 5 | 0 | 2 | 0 |
| 7 | 0 | 2 | 0 |
| 9 | 0 | 3 | 0 |
| 11 | 0 | 3 | 0 |
| 13 | 0 | 3 | 0 |
| 15 | 0 | 3 | 0 |

In case that a NAL unit of highest temporal level is lost, for example the 9-te NAL unit of a GOP in Table 1, it affects only the corresponding picture. In this case the error concealment algorithm can send a new NAL unit to the VCL to avoid an error drift in this temporal level and send a signal to the VCL or renderer directly requesting a picture repeat. Moreover, in respect of complexity and error drift our error concealment method is suitable for a scalable video streaming system. In such system, if the packet loss occurs, the congestion control at the server reduces the number of layers and levels to adapt the sending data rate as described in D. T. Nguyen and J. Ostermann, “Streaming and Congestion Control using Scalable Video Coding based on H.264/AVC,” 15th international Packet Video Workshop, Hangzhou, China, April 2006. Therefore, if the client knows the principle of the congestion control at the server, it can predict the layer and level of the next GOP. in case of two possible valid NAL unit orders the client can switch the current erroneous GOP in this tendency instead of using the motion flag. So the NAL with error concealment can work independent on the VCL.

The error concealment in the NAL can be implemented in the scalable video decoder as described in D. T. Nguyen and J. Ostermann, “Streaming and Congestion Control using Scalable Video Coding based on H.264/AVC,” 15th international Packet Video Workshop, Hangzhou, China, April 2006, which is based on the reference software JSVM 3.0 as described in J. Reichel, H. Schwarz, M. Wien, “Joint Scalable Video Model JSVM-3,” joint Video Team of ITU-T VCEG and iSO/IEC MPEG, Doc. JVT-P2Q2, July 2005 with the extension of IDR-picture for each GOP to allow the spatial layer switching. For the test a bit stream with 600 frames from the sequences Mobile & Calendar and Foreman with GOP size of 1 6 is used. This bit stream has two spatial layers. The lowest spatial layer (layer 0) has QQF resolution and four temporal levels each at 1.875, 3.75, 7.5 and 15 Hz. The higher spatial layer (layer1) has CIF resolution and five temporal levels that give the additional frame rate of 30H.

FIG. 3 shows a graph of the PSNR of scalable video according to the first embodiment. Here, the dashed curve shows the PSNR of output pictures from the erroneous bit stream with 5% loss of NAL units by using the proposed error concealment method and the solid curve gives the PSNR of output pictures from the non-erroneous bit stream for the first 97 pictures. The PSNR calculation is based on the maximal spatial and temporal resolution, namely (CIF, 30 Hz). If a GOP has lower frame rate, the output pictures are repeated to achieve 30 Hz. For GOPs with a spatial resolution of QCIF we use the up-sampling filter in SVC with the following coefficients to obtain higher the spatial resolution GIF.

h[i]-{1,0,−5,0,20,32,20,0,−5,0,1}

In FIG. 3 the pictures from 33 to 49 belong to a GOP with an erroneous NAL unit order. The error concealment method chooses the new order to give the spatial resolution QC1F and a frame rate of 1 5 Hz. This gives soft images with relative smooth motion. For the GOP with the pictures from 65 to 81 the spatial resolution GIF and a frame rate of 1 5 Hz is chosen resulting in sharp images with jerky motion.

The performance of this error concealment method is determined by the selected NAL unit order which is based on the lost packet. This NAL unit order is an order that the server might choose to select based on network condition. Essentially our algorithm selects packets to be ignored based on actually lost packets in a computationally very efficient and pre-computed manner.

Techniques already successfully employed in scalable video coding for achieving temporal and spatial scalability can also be applied in the area of compression of time-consistent 3D mesh sequences. A time-consistent mesh sequence consists of a sequence of 3D meshes (frames). Spatial scalability is achieved by mesh simplification. Removing the same vertices in all frames of the mesh sequence, a mesh sequence with lower spatial resolution is obtained, iterating this procedure several mesh sequences with decreasing spatial resolution corresponding to spatial layers can be generated. The temporal scalability can be realized similar to hierarchical B-pictures in video coding, in this case a current frame of a mesh is predicted from two other frames of the same layer and if applicable from a lower layer. The coded prediction error signal is transmitted in one application data unit. The same quality scalability technique used in video coding can also be applied here for quantization of prediction errors. Again this data is transmitted in an application data unit. Since application data units provide the similar or identical dependencies as in video coding, corresponding processing for error concealment can be applied to the application data units.

In the case of scalable audio coding, if there are application data units exposing similar dependencies as described above, corresponding processing for error concealment can be applied. An example of multiple dependencies between layers would be a system with a scalable mono signal with an additional scalable extension towards a multi-channel signal, in this case parameters can be used to predict the missing channels. The coded prediction error signal is transmitted in application data units. Depending on the lost application data units, one or more audio channels might not be decoded or presented at a lower quality.

The first embodiment relates to an error concealment method applied to the Network Abstraction Layer (NAL) for the scalability extension of H.264/AVC. The method detects loss of NAL units for each group of picture (GOP) and arranges a valid set of NAL units from the available NAL units. In case that there is more than one possibility to arrange a valid set of NAL units, this method uses the information about motion vectors of the preceding pictures to decide if the erroneous GOP will be shown with higher frame rate or higher spatial resolution. This method works without parsing of the NAL unit payload or using of estimation and interpolation to create the lost pictures. Therefore it requires very low computing time and power. Our error concealment method works under the condition that the NAL units of the key pictures, which is the prediction reference picture for other pictures in a GOP, are not lost. The proposed method is the first method suitable for real-time video streaming providing drift-free error concealment at low computational cost.

According to the first embodiment, a method for concealment of packet loss for decoding video, graphics, and audio signals is presented, whereas an error concealment method in the Network Abstraction Layer (NAL) for the scalability extension of H.264/AVC is exemplified. The method can detect the NAL unit loss in a group of pictures (GOP) based on the knowledge that the NAL unit order can be derived from the parameter sets at the beginning of a bit stream. If a NAL unit loss is detected, a valid NAL unit order is arranged from this erroneous NAL unit order. The error concealment method works under the condition that the NAL units of the key pictures are not lost. This method requires low computing power and does not produce error drift. Therefore, it is suitable for real-time video streaming. In some NAL unit loss cases there are two or more possible valid NAL unit orders, one with reduced temporal resolution and the other with reduced spatial resolution. For these cases, the decoder needs to take the decision, for example by deriving a motion flag from the received data. This could be performed by analyzing in the Video Coding Layer (VCL), so that if a lot of motion was observed in the previous pictures, the valid NAL unit order providing higher frame rate is chosen. Otherwise, the valid NAL unit order providing the higher spatial resolution is selected. This approach has two disadvantages. First, the error concealment method needs the decode part of the VCL and second the corresponding original pictures cannot be used to determine the motion flag.

FIG. 4 shows a block diagram of an encoder and a decoder according to a second embodiment. The encoder according to FIG. 4 comprises a video coding layer means VCL and a network abstraction layer means NAL. The video coding layer means will receive the original pictures. The video coding layer means may comprise an error concealment optimiser unit ECO. The error concealment optimiser unit ECO may create a motion flag which can be forwarded to the network abstraction layer NAL. The network abstraction layer NAL will output the NAL units.

The decoder according to the second embodiment comprises a network abstraction layer means NAL and a video coding layer means VCL. The network abstraction layer will comprise a parser P and an error concealment means EC. The video coding layer VCL receives the valid NAL unit order and outputs the reconstructed pictures.

The second embodiment (which can be based on the first embodiment) relates to reducing the complexity at the decoder and to make the error concealment method independent from the VCL. Hence, the motion flag at the encoder is determined and it is signaled in the bit stream or as a separate message like a new SEI message as used in H.264. The VCL is extended by an error concealment optimizer. In the error concealment optimizer the motion flag can be determined by comparing the original pictures or analyzing the motion vectors. For example, the optimizer can calculate the sum of absolute difference (SAD) of the pixels between the original pictures in a GOP. If it is greater than a threshold, the motion flag is set. Or the optimizer can analyze the motion vectors in each pictures of a GOP by calculating their mean and their variance. If these values are greater than a threshold, the motion flag is set. In this case it additionally can use the number of macro-blocks coded with skip mode to affect the decision. A more advanced encoder even can try, whether a reduction of the temporal or the spatial resolution results in lower differences in comparison to the original pictures and set the motion flag accordingly. The comparison can be presented in PSNR which is calculated like in the evaluation according to the first embodiment. Moreover, the more advanced encoder can generate a set of motion flags, one for each of the NAL units, whose loss leads to two possible valid NAL unit orders at the decoder. The motion flags are signaled in the bit stream. In case a new SEI message is defined for this purpose, this message would give hints to the decoder on how to create a valid NAL unit order out of the actually received packets. Hints on how to create valid NAL unit orders may also be derived form existing SEI messages. As an example, the Scene information SEI message may indicate a scene change in which case a NAL unit order with high temporal resolution may be preferable. For no scene change, the high spatial quality may be preferred.

In the scalability extension of H.264/AVC the NAL unit presenting the lowest quality and the lowest spatial resolution of the key picture in a GOP is very important to reconstruct the key picture itself and the other pictures in this GOP. In layered coding, this NAL unit is so-called base layer and the others NAL units of a GOP enhancement layers. Without the base layer the enhancement layers are useless. Therefore, the base layer should be well protected in video transmission normally. For example, the motion flag can be signaled in the extension header of the base layer NAL unit for scalability and therewith it is guaranteed to be readable in decoder if the corresponding GOP or a part of this is reconstructed. In the NAL at the decoder the motion flag is parsed and the decision can be done directly.

The second embodiment relates to an extension of a method for error concealment in application level framing for scalable video coding. The extension is based on an error concealment optimizer which derives control information for cases, where error concealment in application level framing can lead to reduced spatial or temporal resolution due to packet loss. Corresponding control information is signaled in the bit stream to the decoder.

The second embodiment also relates to a method and apparatus, which extends a scalable video encoder by an error concealment optimizer to derive control information for cases, where error concealment in application level framing can lead to reduced spatial or temporal resolution, and signals this control information in the bit stream to the decoder.

1. Method of concealing a packet loss during video decoding, comprising the steps of:
receiving an input stream having a plurality of network abstraction layer units (NAL),
detecting a loss of a network abstraction layer unit in a group of pictures in the input stream,
outputting a valid network abstraction layer unit order from the available network abstraction layer units,
receiving the network abstraction layer unit order by a video coding layer (VCL) and outputting data.

2. Method according to claim 1, wherein if two possible network abstraction layer unit orders are present, the order with the higher frame rate is chosen if the last pictures comprise a lost of motion, otherwise the order with the higher spatial resolution is chosen.

3. Method according to claim 1 or 2, wherein a motion flag is set by the video coding layer (VCL) if the average length of the motion vectors in the last pictures are above a threshold value.

4. Method according to claim 1, 2 or 3, wherein if a network abstraction layer unit is lost during the transmission, a valid network abstraction layer unit order with a lower spatial resolution and/or with a lower frame rate is chosen based on the received and available network abstraction layer unit.

5. Method according to anyone of the claims 1 to 4, wherein a new network abstraction layer unit is forwarded to the video coding layer (VCL) instead of a lost network abstraction layer unit with a high temporal level in order to avoid an error drift.

6. Video coder unit, comprising
a network abstraction layer means (NAL) for receiving an input stream having a plurality of network abstraction layer units for detecting a loss of a network abstraction layer unit in a group of pictures and for outputting a valid network abstraction layer unit order based on the available network abstraction layer units; and
a video coding layer means (VCL) for receiving the network abstraction layer unit order and for outputting data based on the network abstraction layer unit order.

7. Method for concealing errors, in particular according to one of the claims 1 to 5, comprising the steps of:
determining the motion flag by comparing the original pictures or by analysing the motion vectors,
wherein a motion flag is set if these values are greater than a threshold value, and
signalling the motion flag in the bit stream.

8. Method of concealing an error, in particular according to claim 7, comprising the steps of:
receiving a bit stream which may comprise at least one motion flag,
parsing the received bit stream to determine the motion flag,
forwarding the received network abstraction layer units in the input bit stream,
performing an error concealment based on the received network abstraction layer units and the results of the parsing with respect to the motion flags,
wherein the valid network abstraction layer unit order is determined by detecting a loss of a network abstraction layer unit in a group of pictures and by outputting a valid network abstraction layer unit order from the available network abstraction layer units, and
receiving the network abstraction layer unit order and outputting the reconstructed pictures based on the valid network abstraction layer unit order.
